(19) United States
(12) Patent Application Publication
(10) Pub. No.: US 2012/0246191 A1
(43) Pub. Date: Sep. 27, 2012

(54) World-Wide Video Context Sharing

(76) Inventor: True Xiong, San Diego, CA (US)

(21) Appl. No.: 13/070,658

(22) Filed: Mar. 24, 2011

(51) Int. Cl. G06F 15/16; G06F 17/30; G06F 3/048

(52) U.S. Cl. 707/769; 715/769; 709/219; 707/E17.108

(57) ABSTRACT

A request to share an item of content is detected at a computing device. User context information is received for the item of content. A link to a storage location of the item of content is formed. The user context information and the link to the storage location of the item of content are sent to a context-sharing server. The context-sharing server receives the request to share the item of content with the user context information and the link to the storage location of the item of content, stores the received user context information and the link to the storage location of the item of content, and publishes the user context information and the link to the storage location of the item of content as shared content context information. This abstract is not to be considered limiting, since other embodiments may deviate from the features described in this abstract.

### COPYRIGHT AND TRADEMARK NOTICE

A portion of the disclosure of this patent document contains material which is subject to copyright protection. The copyright owner has no objection to the facsimile reproduction of the patent document or the patent disclosure, as it appears in the United States Patent and Trademark Office patent file or records, but otherwise reserves all copyright rights whatsoever. Trademarks are the property of their respective owners.

### BACKGROUND

Social networking websites exist that allow users to create accounts, and to interact with one another and share personal information. Users may authorize other users to access the information they post on these social networking websites. These social networking websites also allow users to upload photographs and text to share with other users within the confines of their user accounts.

### BRIEF DESCRIPTION OF THE DRAWINGS

Certain illustrative embodiments illustrating organization and method of operation, together with objects and advantages may be best understood by reference detailed description that follows taken in conjunction with the accompanying drawings in which:

FIG. 1 is a block diagram of an example of an implementation of a system that provides world-wide video context sharing consistent with certain embodiments of the present invention.

FIG. 2 is a block diagram of an example of an implementation of a core processing module capable of performing automated world-wide video context sharing consistent with certain embodiments of the present invention.

FIG. 3 is a flow chart of an example of an implementation of a process that provides automated world-wide video context sharing via a client computing device consistent with certain embodiments of the present invention.

FIG. 4 is a flow chart of an example of an implementation of a process that provides automated world-wide video context sharing via a context-sharing server device consistent with certain embodiments of the present invention.

FIG. 5 is a flow chart of an example of an implementation of a process that provides automated world-wide video context sharing via a client computing device consistent with certain embodiments of the present invention.

FIG. 6 is a flow chart of an example of an implementation of a process that provides automated world-wide video context sharing via a context-sharing server device consistent with certain embodiments of the present invention.

### DETAILED DESCRIPTION

While this invention is susceptible of embodiment in many different forms, there is shown in the drawings and will herein be described in detail specific embodiments, with the understanding that the present disclosure of such embodiments is to be considered as an example of the principles and not intended to limit the invention to the specific embodiments shown and described. In the description below, like reference numerals are used to describe the same, similar or corresponding parts in the several views of the drawings.

The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically. The term “program” or “computer program” or similar terms, as used herein, is defined as a sequence of instructions designed for execution on a computer system. A “program,” or “computer program,” may include a subroutine, a function, a procedure, an object method, an object implementation, in an executable application, an applet, a servlet, a source code, an object code, a shared library / dynamic load library and/or other sequence of instructions designed for execution on a computer system having one or more processors.

The term “program,” as used herein, may also be used in a second context (the above definition being for the first context). In the second context, the term is used in the sense of a “television program.” In this context, the term is used to mean any coherent sequence of audio video content such as those which would be interpreted as and reported in an electronic program guide (EPG) as a single television program, without regard for whether the content is a movie, sporting event, segment of a multi-part series, news broadcast, etc. The term may also be interpreted to encompass commercial spots and other program-like content which may not be reported as a program in an electronic program guide.

Reference throughout this document to “one embodiment,” “certain embodiments,” “an embodiment,” “an implementation,” “an example” or similar terms means that a particular feature, structure, or characteristic described in connection with the example is included in at least one embodiment of the present invention. Thus, the appearances of such phrases or in various places throughout this specification are not necessarily all referring to the same embodiment. Furthermore, the particular features, structures, or characteristics may be combined in any suitable manner in one or more embodiments without limitation.

The term “or” as used herein is to be interpreted as an inclusive or meaning any one or any combination. Therefore, “A, B or C” means “any of the following: A; B; C; A and B; A and C; B and C; A, B and C.” An exception to this definition will occur only when a combination of elements, functions, steps or acts are in some way inherently mutually exclusive.

The present subject matter provides world-wide video context sharing. Unlike conventional social networking websites, users of the world-wide video context sharing described herein may interact with one another and share information, news, current events, videos, photographs, and any other content or information outside of the confines of the user accounts tied to a particular social networking website, and without uploading or transferring the actual content to other server devices. While users of the subject matter described herein may have accounts with certain social networking websites, these accounts are no longer the exclusive avenue for sharing content and information and users no longer surrender copyrights to content by placing copies of the content on these servers. Users of internet-enabled devices, such as television receiver devices that include an Internet Video Link (IVL), may share, rate, make comments about, and search videos and other content via their internet-enabled devices. When a user wishes to share a video or other content, whether stored locally on the user's internet-enabled device or on a remote server, the user instructs the device to create a “context sticker.” The context sticker as described herein may be considered a graphic (e.g., icon) and/or text object that provides at least two functions. The first function provided by the context sticker is a uniform resource locator (URL) link that attaches to and references the content to be shared. The context sticker may include a hypertext or hypergraphic link based upon the URL. The second function provided by the context sticker is to allow the user to enter information, such as a content rating, comments, a category, keyword(s), or other information, herein termed “context” information, and to attach the entered information to the context sticker. The user's internet-enabled device may then submit the context sticker to one or more servers for publication on websites or search engines administered by the server(s), may integrate the context sticker into a website owned by the user, may integrate the context sticker into an account home page of a social networking website, or may otherwise distribute the context sticker. Any webmaster or user may insert the context sticker into a website along with the URL and entered context information to facilitate sharing of the information.

It should be noted that the present subject matter may be implemented in association with television receiver devices. Television receiver devices may include devices, such as for example, a television set, a set-top box (STB), a set back box, a receiver card, or other device for receiving and decoding television signals, and may further include all IVL devices that support IVL protocols, known in one form commercially via a trademark of Sony Electronics Inc. as BIVL™ and the BIVL™ protocol, respectively, and may include devices such as PS3® devices, VAIO® devices, Blu-Ray® disk (BDP) devices, home audio (HA) products, and Dash® personal Internet viewer devices. The examples herein may utilize the term “television” for ease of reference. However, it is understood that the term “television” may include any television receiver device.

As described above, a user may attach a video or other content for sharing to a context sticker. One possible way to attach a video or other content to a context sticker is for a context-sharing server to provide a social networking website or other server with the context sticker for their users to share and rate videos or other content stored in association with the social networking website or other server. A user of the social networking website may identify a video or other content to share and may associate the content with the provided context sticker, such as by dragging and dropping the content onto the context sticker or otherwise, to update the context sticker with a link to the content stored in association with the social networking website or other server. Association of the context with the context sticker may further cause a dialog to open that allows the user to enter “context” information, as described above, to update the context sticker with content sharing context. The updated context sticker would then initiate sharing of the content and context information with the originating context-sharing server. For example, a reference link to the video may be sent to the sharing server along with metadata information (e.g., comments, rating, geo-location, time, category, keywords, etc.). The geo-location and time may be automatically determined in association with a content sharing event initiated by a user of a computing device. Alternatively, the geo-location may be automatically determined in association with a graphical map representation in response to detection of a user selection of a map location.

An example of the first approach is represented within the first example URL below. For purposes of the present example, it is assumed that the user has a social networking account and has identified an item of content in another user's account postings that the user wishes to share. The user utilizes its own account to post the link. For purposes of the present example, line returns are used to separate portions of the first example URL, though it is understood that line returns would not be needed in a URL or hypertext link that was used to share content and context.

http://campaign.manufacturer.com/share/?
url=http://www.socialwebsite.com/video1.avi&
user=jackAndJill&
category=peace&keywords=gathering&rating=5&
geolocation=123,56,32&time=23452

As can be seen from the first example URL above, the link illustrates a domain of “http://campaign.manufacturer.com/share.” This domain may be considered a “campaign” for shared publication of content. Different campaigns may be managed by a single context-sharing server. Campaigns may also be managed by manufacturers of internet-enabled devices or other components or products. Campaigns may be generalized context sharing campaigns or may be utilized to promote and categorize shared ideas and values, such as for political or ideological promotion or categorization.

The portion of the link “url=http://www.socialwebsite.com/video1.avi” shows that the shared content item is a video within the present example and is created when the user associates the video with the context sticker. As described above, the user may identify a content item already loaded on a social networking website and promote sharing of the content item with added context using the context sticker.

The portion of the link “user=jackAndJill” represents the user account name of the user on the respective social networking website. The portions of the link “category=peace&keywords=gathering&rating=5” represent a category, keyword, and rating assigned by the user as context associated with the context sticker. The portions of the link “geolocation=123,56,32&time=23452” are automatically generated and assigned to the link and represent a geographical location associated with the shared content for added context and a timestamp. The geolocation attribute may be in any format, such as latitude and longitude, address, or any other suitable format. The timestamp attribute may also be in any format appropriate for a given implementation.

Another alternative way to attach a video or other content to a context sticker is for a user device to copy and paste a form URL as a prefix for a video link into her/his own website. The form URL may point to a video posting form and Javascript® that creates a pop-up window for attachment of a content item to share and fills in contextual information for the shared item of content.

An example of the second approach is represented within the second example URL below. For purposes of the present example, line returns are used to separate portions of the second example URL, though it is understood that line returns would not be needed in a URL that was used to share content and context as described herein.

http://campaign.manufacturer.com/share/?
url=http://www.myvideolocation.com/video1.avi&
category=gadgets&keywords=newTool&rating=5&
geolocation=24,56,32&time=234452

As can be seen from the second example URL above, the link illustrates a domain of “http://campaign.manufacturer.com/share,” which is similar to that of the first example URL above. As distinguished from the first example URL above, the second example URL identifies the video content item location as via a URL to a storage location on a discrete server (e.g., other than on a social networking server) as “url=http://www.myvideolocation.com/video1.avi.” This link references a location where the content item is stored, either on a general server accessible via the Internet or on a user's owned server, and there is no need to be affiliated with a social networking website to share this item of content.

Accordingly, for both of the example URLs above, the user may share content and context without forcing uploading or transfer of the actual content item. It is understood that the item of video content within the previous example URLs is not to be considered limiting, as any form of content that may be referenced via a URL may be shared with context as described herein. Further, an item of content may be stored and shared with context in any format, such as Motion Pictures Expert Group (MPEG) format, MPEG Layer-3 Audio (MP3) format, MPEG Layer-4 Audio (MP4) format, three-dimensional (3D) format, or other visual or audible encoded format without departure from the scope and content of the present subject matter. Further, an item of content may include formats for live streaming content supported, for example, as metafile types M3U8, stream types HTTPLS, and container types MPEGTS2. As such, live streaming content may also be shared in real-time using the world-wide video context sharing described herein, and users may view the streamed content with their supported IVL devices as described above and in more detail below. Many other content formats exist and are contemplated, and all such formats are considered to be within the scope of the present subject matter.

As such, a user of any Internet-enabled device that wishes to upload or tag a video to share the video may upload the video or tag an existing video and attach it to a context sticker via one of the two attachment approaches described above, or other attachment approach as appropriate for a given implementation. When a different user browses or searches the Internet and sees the recently uploaded video through random searching or clicking, that user may further share the link by clicking on the context sticker.

In response to detection of a selection of a video in association with a context sticker, the detecting device may form a pop-up dialog with display fields for entry of context for use in sharing the video selection. As such, each user that shares a video may augment and enhance the context data associated with a given content selection. Example dialog fields for entry of contextual information by the user are shown below.
Category:
Keywords:
Rating:
Comments:

It should be noted that additional context information may be added as appropriate for a given implementation. For example, language context information and country context information may be utilized and context stickers may be filtered by regions by IPTV devices and other devices. The following example dialog fields use pre-filled defaults for a language of English (EN) and a country of the United States (USA) and are shown below for purposes of example, though any defaults appropriate for a given implementation may be used. The user may accept these defaults or may enter alternatives for this contextual information.
Language (default: en): EN
Country (default: usa): USA

Further, category and keyword context may be automatically retrieved or derived/inferred from a website or other storage location associated with a video or content item to be shared. As such, a user that wishes to share a video may enter a rating alone, and alternatively any comments they may have to initiate sharing via a context sticker.

The entered or automatically obtained context may then be sent to a context-sharing server (note again, without requiring transmission of the context item itself) for archival and further distribution. In response to receipt of context associated with a context sticker, the context-sharing server may create a context structure that includes the video context name and context created by the user. One possible example format for a context structure is shown below, though it is noted that many possibilities exist for organization of context information associated with context stickers and all are considered within the scope of the present subject matter.
User: [hidden]
Name: Video1
Category: Gadgets
Keywords: newTool
Rating: Rating
Location: 24,56,32
Time: 234452
Internal Counter: Viewed 52,000 times

It should be noted that the user that added the context for the context sticker is shown as hidden within the present example. However, the user name may be published as appropriate for a given implementation, such as for example where a social networking website requires authorization for certain activities. Further, it is noted that the context structure includes a location and time associated with entry of the context. The location and time may be automatically generated by the Internet-enabled device via which the context was created, or by the context-sharing server in response to receipt of the context from a particular device. Further, the user may be prompted for this information and may enter information that forms a part of the context sent to and received by the context-sharing server.

A context search may be automatically performed in response to receipt of context and creation/storage of the context structure. Users that have subscribed to particular context threads may be notified of the new context. For example, for users of Internet video link (IVL) equipment, known in one form commercially via a trademark of Sony Electronics Inc. as BIVL™, and other IVL compatible equipment may be notified by a new reference link updated into an IVL service guide. Alternatively, text notifications may be propagated to users.

While the present subject matter provides improved flexibility with which Internet users may share content, log-in authentication for access to a context-sharing server and posting of context with context stickers may be implemented as appropriate for a given implementation. In such an implementation, in response to a user completing the context form, the user may click a submit button and the pertinent context information may be sent to the context-sharing server. In response to reception of the context information, a new entry may be automatically created within an IVL video context mesh service, for example such as a service called “Context Mesh Videos” or other service name associated with shared context. From an Internet-enabled device that supports an IVL protocol, this context mesh service may be promptly made available and accessible to the viewers/users of such a service.

It should be noted that while the present examples show that actual content is not sent to the context-sharing server, given that not all devices have Internet connectivity at all times, additional context information may be added to allow content download as appropriate for a given implementation. For example, context such as the following example context, may be utilized for user-generated content that does not contain digital rights management (DRM) distribution limitations and may allow download of content when “download” is set to “true.” Such a setting may be made configurable by a user or administrator as appropriate for a given implementation.
downloadable=true

With context data and information collected from the submissions, users may view videos and other content based upon context identifiers, such as locations, categories, keywords, ratings, times, comments, or other available information that forms a portion of the context by which content may be categorized, searched, and retrieved. Many forms of presenting the content are possible. For example, a dashboard application may model a rotating Earth and map all the video and other content by locations, rating, time, or other criteria. With a remote control, touch-screen interface, or other user interface, a user may navigate for example to locations on the displayed rotating earth and hover a cursor over a location. In response to detection of a hover cursor user interface event, more context information associated with available content may be display to the user. A user may subscribe to a location, keyword, category, or other context identifier and notifications may be sent to the user's computing device in response to updated context and/or content associated with subscribed context. Text may be scrolled up, down, left and/or right as a user navigates the rotating Earth dashboard application.

The links associated with the context information may be displayed. Links may be filtered based upon context filter criteria, such as “latest video(s)” or other context filter criteria, and content matching those criteria may be displayed or prioritized among other displayed links as appropriate for a given implementation. Upon selection of the scrolling video text link, the computing device may retrieve or begin streaming the content from the original server or other computing device that stores the content, and content rendering may begin.

Based upon the world-wide video context sharing described herein, journalism, current event reporting, and other aspects of information sharing may be improved. Context associated with content may be rapidly shared without requiring immediate bandwidth or storage. Content may be retrieved from an original storage location and rendered on-demand. As such, bandwidth and storage requirements for content distribution may be improved with a paradigm shift toward on-demand real-time content access by parties that are actually interested in the particular pieces of content.

The technical subject matter described herein may further be utilized to place marketing campaigns into action via the Internet because the present subject matter provides a platform for information flow across multiple products and platforms without conventional information sharing boundaries. Context may be published and distributed in association with products, manufacturers, consumer interests, and other aspects of consumer decision making. Users with existing social networking accounts may publish information (audio, video, etc.) to share content, purchasing experiences, content and product ratings, and other information. Content may further be provided by product manufacturers to product users via the concept of context. For example, IVL equipment may be leveraged to allow anyone to provide content to share to create an “open link” concept, where users may add to context information already published in association with existing content or campaigns. Alternatively, a webmaster may take a snippet of content and make it available via context stickers to several other websites, including social networking websites. Further, a user of a social networking website may create content and upload that content to one service, such as YouTube®, and may publicize the content outside of the one service by use of context stickers. Other users may further propagate published context stickers and add context to them during the process.

It should be noted that this user-interest-based propagation of content outside of a single web service host or account is performed without propagating the actual content. As described above and in more detail below, a link to the content and context information are published and distributed by the use of context stickers. Brand promotion may also be improved by use of context stickers and context propagation outside of single manufacturer product lines. Product type information associated with, for example, a camera used to capture an image, may also be automatically captured and propagated as context in association with the context sticker to further entrench marketing of product lines. Context stickers may also include internal counters of context access and may be queried by manufacturers to determine market distribution of context information. Users may establish preferences for context reception and may create subscriptions to context items using, for example, keywords. Context-sharing servers may update subscribers as new items of content are shared in association with subscribed content.

As such, the present subject matter facilitates a “mash” concept (independent of control by any one entity) for content context based upon user preferences. Context may further be inferred by a context-sharing server based upon user context provided by a user in association with a content share request to allow automated growth of a context base for context sharing and bridging between terms used by different users. The inferred context may be provided in association with context searches and users may accept or modify the inferred context to further refine either the search or the context base. Further, the context-sharing server may translate languages to allow context to be entered in one language, converted to one or more other languages, and shared with users of different languages. The context-sharing server may also identify other forms of content that may be related to a given context thread, such as by the use of inferred context, and may aggregate these related forms of context to create and publish new context threads. To further enhance market presence of context-sharing server manufacturers, context may be modified by the context-sharing server. For example, if a context thread is “video from Jack,” the context-sharing server may append its manufacturer name (e.g., manufacturer) to the context thread for publication as “video from Jack provided by manufacturer” or “video from Jack brought to you by manufacturer.”

The present subject matter may be performed in real time. For purposes of the present description, the term “real time” shall include what is commonly termed “near real time”—generally meaning any time frame of sufficiently short duration as to provide reasonable response time for on demand information processing acceptable to a user of the subject matter described (e.g., within a few seconds or less than ten seconds or so in certain systems). These terms, while difficult to precisely define are well understood by those skilled in the art. It is further understood that the subject matter described herein may be performed in real time and/or near real time.

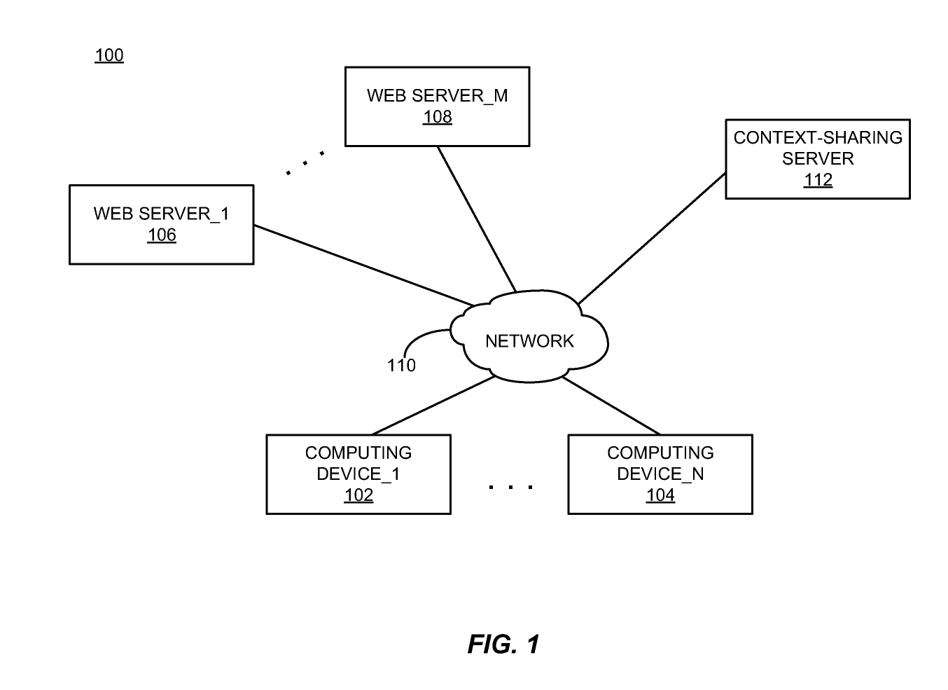

Turning now to FIG. 1, FIG. 1 is a block diagram of an example of an implementation of a system 100 that provides world-wide video context sharing. A computing device_1 102 through a computing device_N 104 communicate with and access content stored in association with a web server_1 106 through a web server_M 108 via a network 110. The computing device_1 102 through the computing device_N 104 may also store content. Any of the stored content may be shared as described above and in more detail below to provide world-wide video context sharing without transmission of the actual content at the time of context sharing. As such, bandwidth and storage within the system 100 may be improved.

A context-sharing server 112 interacts with the computing device_1 102 through the computing device_N 104 to facilitate context sharing within the system 100. Each of the computing device_1 102 through the computing device_N 104 may act as a proxy context agent and may provide context information to the context-sharing server 112. Each of the computing device_1 102 through the computing device_N 104 may also subscribe to content context threads and, in response to any of the computing device_1 102 through the computing device_N 104 posting context associated with a particular subscribed context, the context-sharing server 112 may propagate context updates to each respective subscribed computing device. The context-sharing server 112 may be any computing device capable of processing information as described above and in more detail below. For example the context-sharing server 112 may include a personal computer (e.g., desktop, laptop, etc.), a server computer, or other computing device without departure from the scope of the present subject matter.

It should be noted that the computing device_1 102 through the computing device_N 104 may include computing devices that are portable, either by a user's ability to move the respective computing device to different locations, or by the respective computing device's association with a portable platform, such as a plane, train, automobile, or other moving vehicle. It should also be noted that the computing device_1 102 through the computing device_N 104 may be any computing device capable of processing information as described above and in more detail below. For example, the computing device_1 102 through the computing device_N 104 may include devices such as a personal computer (e.g., desktop, laptop, etc.) or a handheld device (e.g., cellular telephone, personal digital assistant (PDA), email device, music recording or playback device, etc.), or any other device capable of processing information as described in more detail below.

The web server_1 106 through the web server_M 108 may be any network-based server accessible via the network 110 that may store audio and/or video (A/V) content. The web server_1 106 through the web server_M 108 may further include social networking servers. Examples of web-based servers that are presently within the marketplace are Amazon.com®, Yahoo!®, AOL®, Facebook®, and LinkedIn®, among others. Many other network accessible web-based servers and social networking servers exist and many others are contemplated by the present subject matter. Accordingly, the world-wide video context sharing described herein may be utilized in association with all such network-accessible web-based servers and such use is considered within the scope of the present subject matter.

The network 110 may include any form of interconnection suitable for the intended purpose, including a private or public network such as an intranet or the Internet, respectively, direct inter-module interconnection, dial-up, wireless, or any other interconnection mechanism capable of allowing communication between devices. An example of a web-based protocol suitable for providing communication over the network 110 is the transmission control protocol over Internet protocol (TCP/IP). Markup language formatting, such as the hypertext transfer protocol (HTTP) and extensible markup language (XML) formatting, may be used for messaging over the TCP/IP connection with devices accessible via the network 110. Other web protocols exist and all are considered within the scope of the present subject matter. As described above, the web server_1 106 through the web server_M 108 may be any device or Internet server or service that stores A/V content that is accessible via the network 110, including social media website servers.

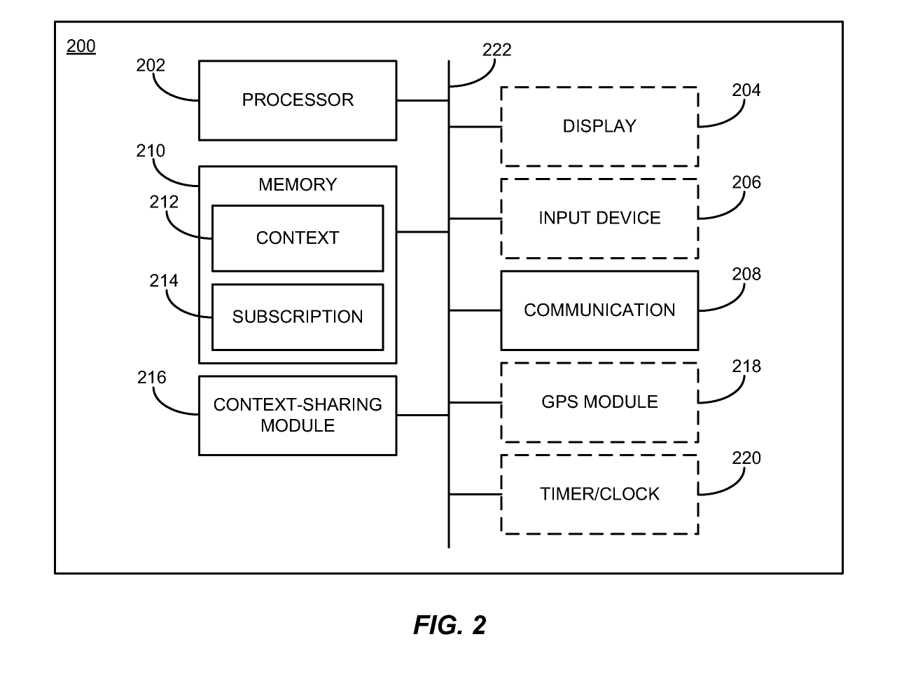

FIG. 2 is a block diagram of an example of an implementation of a core processing module 200 capable of performing automated world-wide video context sharing. The core processing module 200 may be associated any of the computing device_1 102 through the computing device_N 104, or the context-sharing server 112, as appropriate for a given implementation. Further, the core processing module 200 may provide different and complementary processing of shared context in association with each implementation, as described in more detail below.

A processor 202 provides computer instruction execution, computation, and other capabilities within the core processing module 200. A display device 204 provides visual and/or other information to a user of the core processing module 200. The display device 204 may include any type of display device, such as a cathode ray tube (CRT), liquid crystal display (LCD), light emitting diode (LED), electronic ink displays, projection or other display element or panel. An input device 206 provides input capabilities for the user. The input device 206 may include a mouse, pen, trackball, or other input device. One or more input devices, such as the input device 206, may be used.

It should be noted that the display device 204 and the input device 206 are illustrated with a dashed-line representation within FIG. 2 to indicate that they may be optional components for the core processing module 200 for certain implementations. For example, where the core processing module 200 is associated with the context-sharing server 112, the display device 204 and the input device 206 may be omitted and the context-sharing server 112 may be accessed for configuration and other purposes via the network 110 or other interface (not shown). Alternatively, the display device 204 and the input device 206 may be utilized in association with the core processing module 200 to provide administrative access to the context-sharing server 112 without use of the network 110. Accordingly, the core processing module 200 may operate as a completely automated embedded device without direct user configurability or feedback. However, the core processing module 200 may also provide user feedback and configurability via the display device 204 and the input device 206, respectively.

A communication module 208 provides communication capabilities for interaction with the core processing module 200, such as for access to one of the web server_1 106 through the web server_M 108 and the context-sharing server 112. The communication module 208 may support wired or wireless standards appropriate for a given implementation. Example wired standards include Internet video link (IVL) interconnection within a home network, for example, such as Sony Corporation's Bravia® Internet Video Link (BIVL™). Example wireless standards include cellular wireless communication and Bluetooth® wireless communication standards. Many other wired and wireless communication standards are possible and all are considered within the scope of the present subject matter. The communication module 208 may further include Internet video link (IVL) compatible communication capabilities.

A memory 210 includes a context storage area 212. The context storage area 212 may store user generated context and links (URLs) to content items generated in response to detection of a user-initiated content sharing request, as described above and in more detail below. The context storage area 212 may also store context stickers, which, as described above, may include an icon, logo, text object, or other graphic, and the user generated context and URLs to content items that have been assigned to context stickers. Further, if the content is downloadable, the content may be downloaded to a cloud storage area that may be accessible to any devices belonging to a particular user's account. As such, the context storage area 212 may further store content and form a cloud storage area as appropriate for a given implementation.

The memory 210 also includes a subscription storage area 214 that may store context-based subscription information. The context-sharing server 112 may utilize subscription information about context that certain subscribing devices, such as the computing device_1 102 through the computing device_N 104, for distribution of context update notifications to subscribing devices. Further, the computing device_1 102 through the computing device_N 104 may store subscribed context threads and notifications within the subscription storage area 214.

It should be noted that the memory 210 may also store content for sharing, such as when implemented in association with any of the computing device_1 102 through the computing device_N 104. However, as the present subject matter is directed to context sharing without requiring transmission and storing of content, longer-term storage of content at any of the computing device_1 102 through the computing device_N 104 may not be utilized for any given implementation of the present subject matter. It is understood that any of the computing device_1 102 through the computing device_N 104 may share content stored either locally or at other computing devices or web servers using context stickers either generated by the respective computing device or the context-sharing server 112 as described above and in more detail below.

The memory 210 may include any combination of volatile and non-volatile memory suitable for the intended purpose, distributed or localized as appropriate, and may include other memory segments not illustrated within the present example for ease of illustration purposes. For example, the memory 210 may include a code storage area, an operating system storage area, a code execution area, and a data area without departure from the scope of the present subject matter.

A context-sharing module 216 is also illustrated. The context-sharing module 216 provides context sticker processing and context sharing capabilities for the core processing module 200, as described above and in more detail below. The context-sharing module 216 implements the automated world-wide video context sharing of the core processing module 200. As described above and in more detail below, the context-sharing module 216 may operate in response to user requests detected at any of the computing device_1 102 through the computing device_N 104 to share content stored either within the memory 210 or content stored in association with one or more of the web server_1 106 through the web server_M 108. The context-sharing module 216 may also operate as a context gathering proxy for the context-sharing server 112 when implemented in association with any of the computing device_1 102 through the computing device_N 104.

A global positioning system (GPS) module 218 provides positioning location coordinates usable for identifying, for example, a geo-location of entry of context information. Location identification information generated by the GPS module 218 may be stored within the context storage area 212 for use by the context-sharing module 216.

A timer/clock module 220 is illustrated and used to determine timing and date of entry of information, such as context information, as described above and in more detail below. As such, the context-sharing module 216 may utilize information derived from the timer/clock module 220 for information processing activities, such as the world-wide video context sharing described herein.

The GPS module 218 and the timer/clock module 220 are illustrated with a dashed-line representation within FIG. 2 to indicate that they may be optional components for the core processing module 200 for certain implementations. For example, where the core processing module 200 is associated with one of the computing device_1 102 through the computing device_N 104, the GPS module 218 and timer/clock module 220 may be utilized to automatically capture context information.

It should be noted that the modules described above in association with the core processing module 200 are illustrated as component-level modules for ease of illustration and description purposes. It is also understood that these modules include any hardware, programmed processor(s), and memory used to carry out the respective functions of these modules as described above and in more detail below. For example, the respective modules may include additional controller circuitry in the form of application specific integrated circuits (ASICs), processors, antenna(s), and/or discrete integrated circuits and components for performing electrical control activities. Additionally, the modules may include interrupt-level, stack-level, and application-level modules as appropriate. Furthermore, the modules may include any memory components used for storage, execution, and data processing by these modules for performing the respective processing activities. The modules may also form a portion of other circuitry described below without departure from the scope of the present subject matter.

It should also be noted that the context-sharing module 216 may form a portion of other circuitry described without departure from the scope of the present subject matter. Further, the context-sharing module 216 may alternatively be implemented as an application stored within the memory 210. In such an implementation, the context-sharing module 216 may include instructions executed by the processor 202 for performing the functionality described herein. The processor 202 may execute these instructions to provide the processing capabilities described above and in more detail below for the core processing module 200. The context-sharing module 216 may form a portion of an interrupt service routine (ISR), a portion of an operating system, a portion of a browser application, or a portion of a separate application without departure from the scope of the present subject matter.

The processor 202, the display device 204, the input device 206, the communication module 208, the memory 210, the context-sharing module 216, the GPS module 218, and the timer/clock module 220 are interconnected via one or more interconnections shown as interconnection 222 for ease of illustration. The interconnection 222 may include a system bus, a network, or any other interconnection capable of providing the respective components with suitable interconnection for the respective purpose.

Furthermore, components within the core processing module 200 may be co-located or distributed within a network without departure from the scope of the present subject matter. For example, the components within the core processing module 200 may be located within a stand-alone device, such as a personal computer (e.g., desktop or laptop) or handheld device (e.g., cellular telephone, personal digital assistant (PDA), tablet computer, E-book, email device, music recording or playback device, etc.). For a distributed arrangement, the display device 204 and the input device 206 may be located at a kiosk, while the processor 202 and memory 210 may be located at a local or remote server. Many other possible arrangements for the components of the core processing module 200 are possible and all are considered within the scope of the present subject matter.

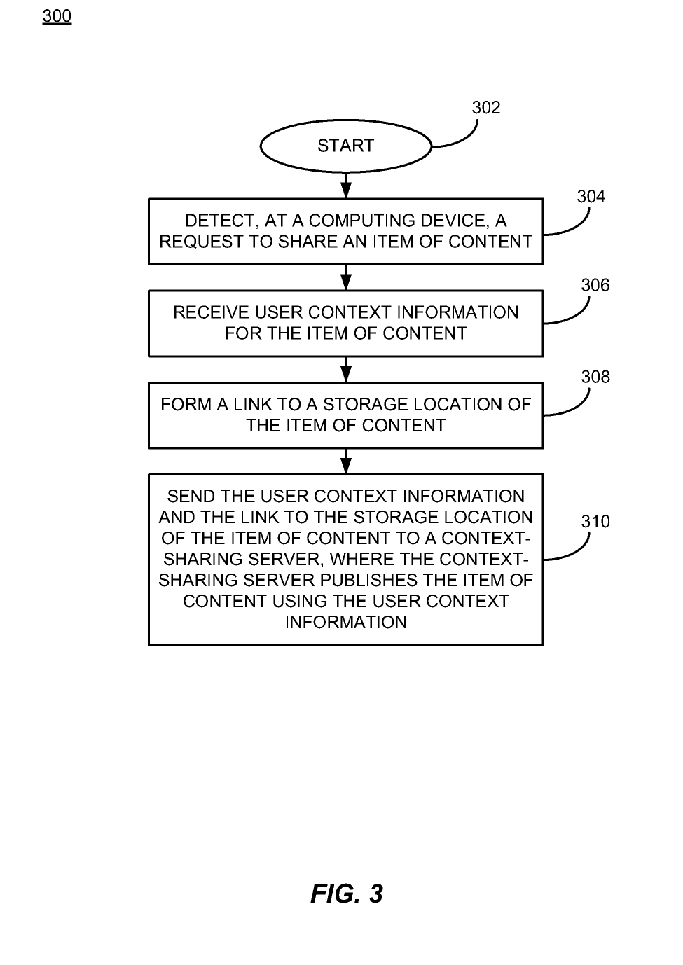

FIG. 3 through FIG. 6 below describe example processes that may be executed by such devices, such as the core processing module 200, to perform the automated world-wide video context sharing associated with the present subject matter. Many other variations on the example processes are possible and all are considered within the scope of the present subject matter. The example processes may be performed by modules, such as the context-sharing module 216 and/or executed by the processor 202, associated with such devices. It should be noted that time out procedures and other error control procedures are not illustrated within the example processes described below for ease of illustration purposes. However, it is understood that all such procedures are considered to be within the scope of the present subject matter.

FIG. 3 is a flow chart of an example of an implementation of a process 300 that provides automated world-wide video context sharing via a client computing device, such as one of the computing device_1 102 through the computing device_N 104. The process 300 starts at 302. At block 304, the process 300 detects, at a computing device, a request to share an item of content. At block 306, the process 300 receives user context information for the item of content. At block 308, the process 300 forms a link to a storage location of the item of content. At block 310, the process 300 sends the user context information and the link to the storage location of the item of content to a context-sharing server, where the context-sharing server publishes the item of content using the user context information.

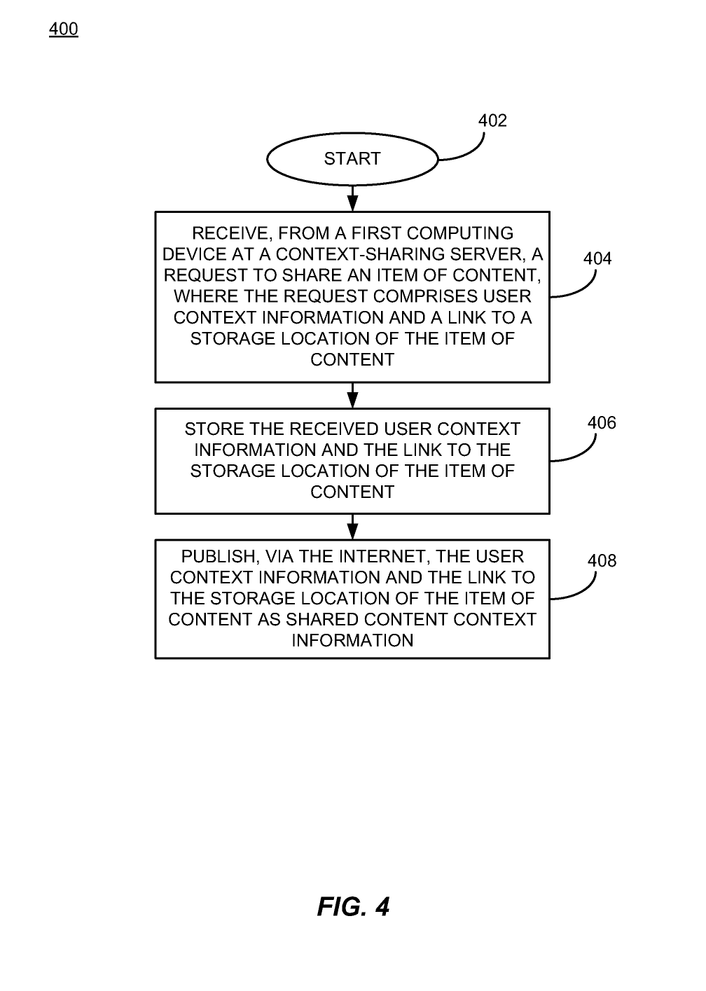

FIG. 4 is a flow chart of an example of an implementation of a process 400 that provides automated world-wide video context sharing via a context-sharing server device, such as the context-sharing server 112. The process 400 starts at 402. At block 404, the process 400 receives, from a first computing device at the context-sharing server, a request to share an item of content, where the request comprises user context information and a link to a storage location of the item of content. At block 406, the process 400 stores the received user context information and the link to the storage location of the item of content. At block 408, the process 400 publishes, via the Internet, the user context information and the link to the storage location of the item of content as shared content context information.

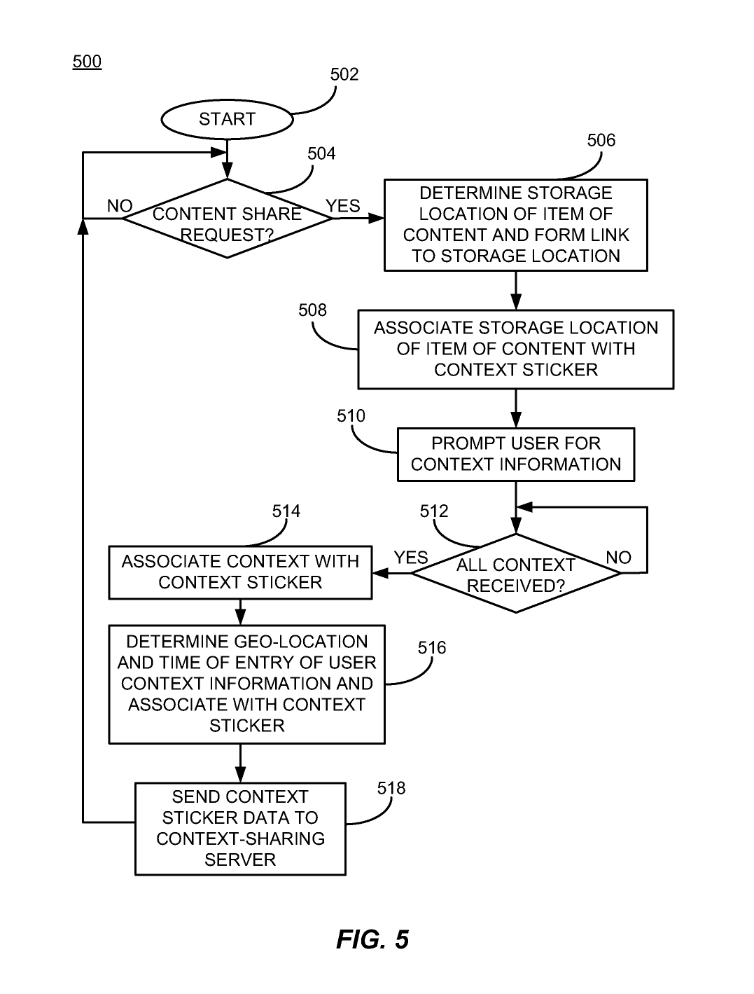

FIG. 5 is a flow chart of an example of an implementation of a process 500 that provides automated world-wide video context sharing via a client computing device, such as one of the computing device_1 102 through the computing device_N 104. For purposes of the present description, a client computing device may be considered a context gathering proxy device/agent for a context-sharing server, such as the context-sharing server 112. The process 500 starts at 502.

At decision point 504, the process 500 makes a determination as to whether a content share request has been detected. For example, the process 500 may detect a menu selection to create a context sticker for an item of content rendered on a display, such as the display device 204 of the respective computing device. Alternatively, the process 500 may detect a selection of a context sticker rendered via a display of the respective computing device. The context sticker may form a portion of content associated with a web site, including a social networking website, hosted by one of the web server_1 106 through the web server_M 108. As such, a context sticker may be rendered via the display device 204 of the respective computing device in association with rendering a social networking website on the display of the computing device. As another alternative, the process 500 may detect a drag and drop user interface operation of an image icon representing the item of content onto a context sticker associated with a web site.

In response to determining that a request to share an item of content has been detected, the process 500 determines a storage location of the item of content and forms a link (e.g., URL) to the storage location of the item of content at block 506. The item of content to be shared may be stored at the computing device executing the process 500 or stored at a web server, such as one of the web server_1 106 through the web server_M 108. As such, the process 500 may determine that the storage location of the item of content includes a social networking website storage location or a storage location of the computing device executing the process 500. Accordingly, the process 500 may form the link to the social networking website storage location.

At block 508, the process 500 associates the storage location of the item of content to be shared with a context sticker. As described above, the process 500 may, for example, detect a selection of a context sticker rendered via a display of the respective computing device or detect a drag and drop user interface operation of an image icon representing the item of content onto a context sticker associated with a web site. As such, the process 500 may associate the URL to the storage location of the item of content with the context sticker. Alternatively, where the process 500 detects a menu selection to create a context sticker for the item of content rendered on a display, the process 500 may create a context sticker including a link to the storage location of the item of content at block 508. As such, the process 500 may operate as a proxy for the context-sharing server 112 to create the context sticker for use by the context-sharing server 112 to be published as a context element associated with the item of content to be shared.

At block 510, the process 500 prompts, via a user interface dialog box in response to detecting the request to share the item of content, the user to enter user context information. As described above, the user context information may include at least one of a user comment, a user rating, a user assigned context category, and a user assigned context keyword, among other possible context items. The user context information may further include a social networking account identifier of a user that originated the detected request to share the item of content. The social networking account identifier may be automatically determined in association with the processing of the process 500.

At decision point 512, the process 500 makes a determination as to whether all user-entered context for the item of content to be shared has been received. For example, the process 500 may receive the user context information for the item of content in response to entry of the user context information within the user interface dialog box rendered on the display device 204.

In response to determining that all user-entered context for the item of content to be shared has been received at decision point 512, the process 500 associates the user-entered context with the context sticker at block 514. The process 500 may further associate a context sticker identifier (ID) with the context sticker at block 514.

At block 516, the process 500 determines a geo-location and a time of entry of the user context information and associates the determined geo-location and time of entry of the user context information with the context sticker. It should be noted that the geo-location may alternatively be associated with the context and content, and the time of entry may be associated with a time of relevance to the context and content. At block 518, the process 500 sends the context sticker including the user context information, the link to the storage location of the item of content, the context sticker identifier (ID) of the context sticker, the geo-location, and the time of entry of the user context information to a context-sharing server, such as the context-sharing server 112. As described above, where the process 500 operates in association with a computing device that includes IVL communication capabilities, the process 500 may send the link to the storage location of the item of content, the context sticker identifier (ID) of the context sticker, the geo-location, and the time of entry of the user context information to the context-sharing server via the IVL. The process 500 returns to decision point 504 and iterates as described above.

As such, the process 500 responds to a variety of detected requests to share an item of content, determines a storage location of the item of content, and forms a link (e.g., URL) to the item of content. The process prompts the user for context information and creates or updates a context sticker with the entered context information. The process determines a geo-location and time of entry of the user context and sends the context sticker with the entered or determined information to the context-sharing server. As such, the item of content does not need to be communicated to the context-sharing server to facilitate context sharing and sharing of the item of content with others. Bandwidth and storage may be reduced in association with content sharing via the processing described herein.

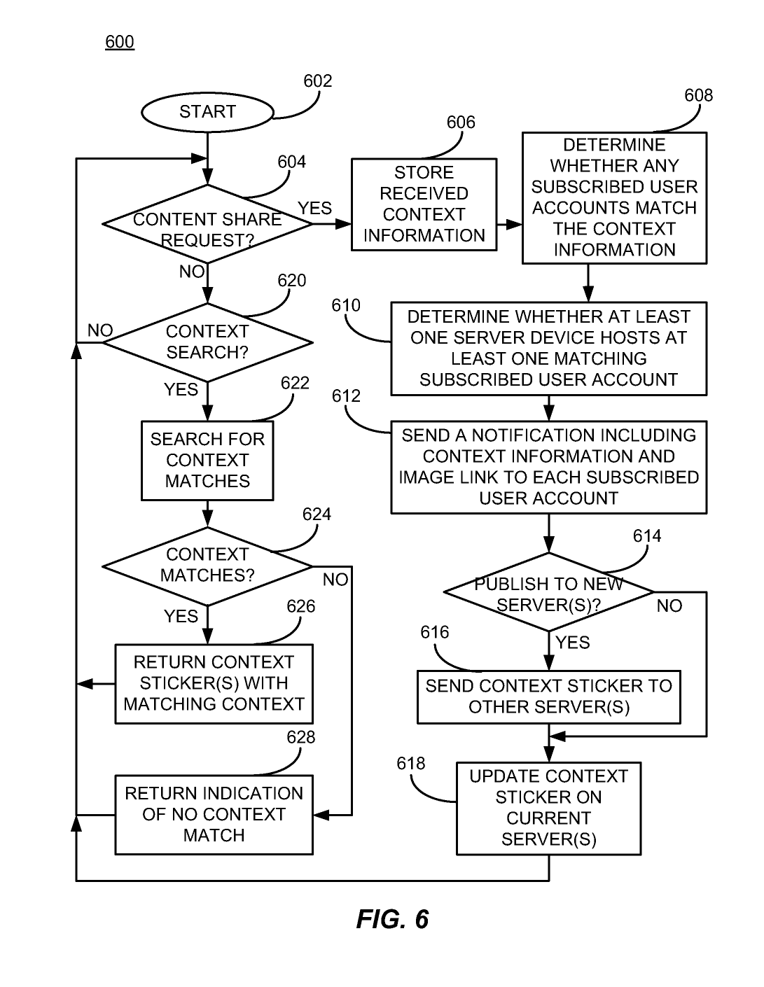

FIG. 6 is a flow chart of an example of an implementation of a process 600 that provides automated world-wide video context sharing via a context-sharing server device, such as the context-sharing server 112. The process 600 starts at 602.

At decision point 604, the process 600 begins higher-level processing and makes a determination as to whether a request to share an item of content has been received, such as for example from one of the computing device_1 102 through the computing device_N 104. As described above, such computing devices may operate as context gathering proxy devices for the context-sharing server 112. The request may include user and automatically generated context information and a link to a storage location of the item of content, as described above in association with FIG. 5. As also described above, the storage location may include a storage location associated with a computing device other than the computing device that issues the request, or the storage location may be associated with the requesting computing device. In either situation, the content itself does not need to be transmitted to share the context information, and ultimately the content itself. As such, the content may be consumed on demand as users find context of interest. Further, the context information may include a context sticker, a context sticker identifier (ID) of a context sticker published by the context-sharing server, a geo-location associated with the context and content, and a time of entry of the user context information or a time of relevance to the context and content.

In response to determining that a request to share an item of content has been received, the process 600 stores the received context information at block 606. At block 608, the process 600 determines whether any subscribed user accounts have subscribed context identifiers that match the received context information. At block 610, the process 600 determines whether at least one server device hosts at least one matching subscribed user account. At block 612, the process 600 publishes the user context information and the link to the storage location of the item of content as the shared content context information by sending a notification including the context information and the link to each subscribed user account. Sending the notification may include sending a context sticker, a context sticker identifier (ID) of a context sticker published by the context-sharing server, the geo-location associated with the context and content, and the time of entry of the user context information or a time of relevance to the context and content.

At decision point 614, the process 600 makes a determination as to whether to publish the received context information to one or more new servers. For example, where a social networking website is dedicated to a particular form of information, such as coin collecting for example, the process 600 may determine that new context information associated with the social networking website has been received. As such, in response to determining to publish the received context information to one or more new servers, the process 600 sends the context sticker to the one or more other servers at block 616.

In response to determining not to publish the received context information to one or more new servers at decision point 614, or in response to sending the context sticker to one or more new servers at block 616, the process 600 updates the context sticker associated with any current published locations/servers at block 618. The process 600 then returns to decision point 604 and iterates as described above.

Returning to the description of decision point 604, in response to determining that a content share request has not been received, or upon completion of processing any existing content share requests and a determination that a new content share request has not been received, the process 600 makes a determination as to whether a context search request has been received at decision point 620. The context search request may include context identifying text for use in association with performing a context search, or the process 600 may prompt a user to enter context identifying text (not shown). In response to determining that a context search request has not been received, the process 600 returns to decision point 604 and iterates as described above.

In response to determining that a context search request has been received, the process 600 performs a search of stored context information for context matches at block 622. At decision point 624, the process 600 makes a determination as to whether at least one matching stored context information item is identified during the search. As described above, the stored context information may include the received user context information and the link to the storage location of the item of content, along with other context information.

In response to determining that at least one matching stored context information item is identified during the search, the process 600 returns a context sticker with the matching user context information and the link to the storage location of the item of content at block 626. The process 600 may alternatively return additional context information, such as the additional context information described above. In response to determining that no matching stored context information item is identified during the search, the process 600 returns an indication that no context match has been identified at block 628. In response to either returning the context sticker with the matching user context information and the link to the storage location of the item of content at block 626, or returning the indication that no context match has been identified at block 628, the process 600 returns to decision point 604 at iterates as described above.

As such, the process 600 processes requests to share content by use of context information and links to the content stored in its current storage location without requiring transmission of the content itself. The process 600 also processes search requests for content items stored at locations other than at the context-sharing server.

Thus, in accord with certain implementations, a method of context-based content sharing at a computing device involves detecting, at the computing device that includes a television receiver device with an Internet video link (IVL) that operates as a context gathering proxy device for a context-sharing server, a drag and drop user interface operation of an image icon representing an item of content onto a context sticker rendered via a display of the computing device as part of rendering a social networking website, where the drag and drop user interface operation of the image icon representing the item of content onto the context sticker includes a request to share the item of content; prompting, via a user interface dialog box in response to detecting the drag and drop user interface operation of the image icon representing the item of content onto the context sticker, a user to enter user context information for the item of content; receiving the user context information for the item of content in response to the user entry of the user context information within the user interface dialog box; determining that a storage location of the item of content includes a social networking website storage location; forming a link to the social networking website storage location of the item of content; determining a geo-location and a time of entry of the user context information; and sending the user context information, the link to the storage location of the item of content, a context sticker identifier (ID) of the context sticker, the geo-location, and the time of entry of the user context information to the context-sharing server via the IVL, where the context-sharing server publishes the item of content using the user context information.

In certain implementations, the method of context-based content sharing at a computing device involves detecting, at the computing device, a request to share an item of content; receiving user context information for the item of content; forming a link to a storage location of the item of content; and sending the user context information and the link to the storage location of the item of content to a context-sharing server, where the context-sharing server publishes the item of content using the user context information.

In certain implementations, the method of context-based content sharing at a computing device involving detecting, at the computing device, the request to share the item of content involves detecting a menu selection to create a context sticker for the item of content, and creating the context sticker including the user context information and the link to the storage location of the item of content, where the context sticker includes a context sticker icon; and the method of sending the user context information and the link to the storage location of the item of content to a context-sharing server involves sending the context sticker to the context-sharing server. In certain implementations, the method of detecting, at the computing device, the request to share the item of content involves detecting a selection of a context sticker rendered via a display of the computing device. In certain implementations, the context sticker is rendered via the display of the computing device in association with rendering a social networking website on the display of the computing device. In certain implementations, the method of detecting, at the computing device, the request to share the item of content involves detecting a drag and drop user interface operation of an image icon representing the item of content onto a context sticker. In certain implementations, the method further involves sending the context sticker to the context-sharing server. In certain implementations, the method further involves sending a context sticker identifier (ID) of the context sticker to the context-sharing server. In certain implementations, the method further involves prompting, via a user interface dialog box in response to detecting the request to share the item of content, a user to enter the user context information; and the method of receiving the user context information for the item of content involves receiving the user context information in response to user entry of the user context information within the user interface dialog box. In certain implementations, the method further involves determining that the storage location of the item of content includes a social networking website storage location; and the method of forming the link to the storage location of the item of content involves forming the link to the social networking website storage location. In certain implementations, the computing device includes a television receiver device with an Internet video link (IVL), and the method of sending the user context information and the link to the storage location of the item of content to the context-sharing server involves sending the user context information and the link to the storage location of the item of content to the context-sharing server via the IVL. In certain implementations, the user context information includes at least one of a user comment, a user rating, a user assigned context category, and a user assigned context keyword. In certain implementations, the method further involves determining a geo-location and a time of entry of the user context information; and the method of sending the user context information and the link to the storage location of the item of content to the context-sharing server involves sending the geo-location and the time of entry of the user context information to the context-sharing server. In certain implementations, the user context information further includes a social networking account identifier of a user that originated the detected request to share the item of content. In certain implementations, the computing device operates as a context gathering proxy device for the context-sharing server.

In another implementation, a computer readable storage medium may store instructions which, when executed on one or more programmed processors, carry out a process of context-based content sharing at a computing device involving detecting, at the computing device, a request to share an item of content; receiving user context information for the item of content; forming a link to a storage location of the item of content; and sending the user context information and the link to the storage location of the item of content to a context-sharing server, where the context-sharing server publishes the item of content using the user context information.

In another implementation, a method of context-based content sharing at a context-sharing server involves receiving, from a first computing device at the context-sharing server, a request to share an item of content, where the request includes user context information and a link to a storage location of the item of content; storing the received user context information and the link to the storage location of the item of content; and publishing, via the Internet, the user context information and the link to the storage location of the item of content as shared content context information.

In certain implementations, the method of context-based content sharing at a context-sharing server involving receiving the request to share the item of content involves receiving a context sticker identifier (ID) of a context sticker previously published by the context-sharing server at a social networking server accessed by the first computing device; and publishing, via the Internet, the user context information and the link to the storage location of the item of content as shared content context information involves updating published context information associated with the context sticker. In certain implementations, the method of receiving the request to share the item of content involves receiving a context sticker and storing the context sticker with the user context information and the link to the storage location of the item of content. In certain implementations, the method further involves determining whether any subscribed user accounts match the user context information; determining, in response to determining that at least one subscribed user account matches the user context information, whether at least one server device hosts the matching at least one subscribed user account that matches the user context information; and the method of publishing the user context information and the link to the storage location of the item of content as the shared content context information involves sending the context sticker with the user context information and the link to the storage location of the item of content to the at least one server device that hosts the subscribed user accounts that match the user context information. In certain implementations, the method further involves determining whether any subscribed user accounts match the user context information; and the method of publishing the user context information and the link to the storage location of the item of content as the shared content context information involves sending a notification including the user context information and the link to the storage location of the item of content to each subscribed user account determined to match the user context information. In certain implementations, the method further involves receiving a search request including context identifying text; performing a context search of stored context information for context matches; identifying at least one matching stored context information item, where the at least one matching stored context information item includes the received user context information and the link to the storage location of the item of content; and returning the matched user context information and the link to the storage location of the item of content in response to the search request. In certain implementations, the storage location of the item of content includes a storage location associated with a second computing device. In certain implementations, the first computing device operates as a context gathering proxy device for the context-sharing server. In certain implementations, the first computing device includes a social networking server.

In another implementation, a computer readable storage medium may store instructions which, when executed on one or more programmed processors, carry out a process of context-based content sharing at a context-sharing server involving receiving, from a first computing device at the context-sharing server, a request to share an item of content, where the request includes user context information and a link to a storage location of the item of content; storing the received user context information and the link to the storage location of the item of content; and publishing, via the Internet, the user context information and the link to the storage location of the item of content as shared content context information.

An apparatus for context-based content sharing, consistent with certain implementations, has a communication interface and a processor programmed to detect a request to share an item of content; receive user context information for the item of content; form a link to the storage location of the item of content; and send, via the communication interface, the user context information and the link to the storage location of the item of content to a context-sharing server, where the context-sharing server publishes the item of content using the user context information.

In certain implementations, in being programmed to detect the request to share the item of content, the processor is programmed to detect a menu selection to create a context sticker for the item of content; create the context sticker including the user context information and the link to the storage location of the item of content, where the context sticker includes a context sticker icon; and, in being programmed to send the user context information and the link to the storage location of the item of content to a context-sharing server, the processor is programmed to send the context sticker to the context-sharing server. In certain implementations, the apparatus has a display; and, in being programmed to detect the request to share the item of content, the processor is programmed to detect a selection of a context sticker rendered via the display. In certain implementations, the processor is programmed to render the context sticker via the display in association with rendering a social networking website on the display. In certain implementations, in being programmed to detect the request to share the item of content, the processor is programmed to detect a drag and drop user interface operation of an image icon representing the item of content onto a context sticker. In certain implementations, the processor is further programmed to send the context sticker to the context-sharing server. In certain implementations, the processor is further programmed to send a context sticker identifier (ID) of the context sticker to the context-sharing server. In certain implementations, the processor is further programmed to prompt, via a user interface dialog box in response to detecting the request to share the item of content, a user to enter the user context information; and, in being programmed to receive the user context information for the item of content, the processor is programmed to receive the user context information in response to user entry of the user context information within the user interface dialog box. In certain implementations, the processor is further programmed to determine that the storage location of the item of content includes a social networking website storage location; and, in being programmed to form the link to the storage location of the item of content, the processor is programmed to form the link to the social networking website storage location. In certain implementations, the apparatus has a television receiver device with an Internet video link (IVL), and, in being programmed to send the user context information and the link to the storage location of the item of content to the context-sharing server, the processor is programmed to send the user context information and the link to the storage location of the item of content to the context-sharing server via the IVL. In certain implementations, the user context information includes at least one of a user comment, a user rating, a user assigned context category, and a user assigned context keyword. In certain implementations, the apparatus has a global positioning system (GPS) module and a clock module; the processor is further programmed to determine a geo-location via the GPS module, and a time of entry of the user context information via the clock module; and, in being programmed to send the user context information and the link to the storage location of the item of content to the context-sharing server, the processor is programmed to send the geo-location and the time of entry of the user context information to the context-sharing server. In certain implementations, the user context information further includes a social networking account identifier of a user that originated the detected request to share the item of content. In certain implementations, the apparatus operates as a context gathering proxy device for the context-sharing server.

An apparatus for of context-based content sharing, consistent with certain implementations, has a memory, and a processor programmed to receive, from a first computing device, a request to share an item of content, where the request includes user context information and a link to a storage location of the item of content; store the received user context information and the link to the storage location of the item of content within the memory; and publish, via the Internet, the user context information and the link to the storage location of the item of content as shared content context information.

In certain implementations, in being programmed to receive the request to share the item of content, the processor is programmed to receive a context sticker identifier (ID) of a context sticker previously published by the context-sharing server at a social networking server accessed by the first computing device; and, in being programmed to publish, via the Internet, the user context information and the link to the storage location of the item of content as shared content context information, the processor is programmed to update published context information associated with the context sticker. In certain implementations, in being programmed to receive the request to share the item of content, the processor is programmed to receive a context sticker and store the context sticker with the user context information and the link to the storage location of the item of content within the memory. In certain implementations, the processor is further programmed to determine whether any subscribed user accounts match the user context information; determine, in response to determining that at least one subscribed user account matches the user context information, whether at least one server device hosts the matching at least one subscribed user account that matches the user context information; and, in being programmed to publish the user context information and the link to the storage location of the item of content as the shared content context information, the processor is programmed to send the context sticker with the user context information and the link to the storage location of the item of content to the at least one server device that hosts the subscribed user accounts that match the user context information. In certain implementations, the processor is further programmed to determine whether any subscribed user accounts match the user context information; and, in being programmed to publish the user context information and the link to the storage location of the item of content as the shared content context information, the processor is programmed to send a notification including the user context information and the link to the storage location of the item of content to each subscribed user account determined to match the user context information. In certain implementations, the processor is further programmed to receive a search request including context identifying text; perform a context search of stored context information for context matches; identify at least one matching stored context information item, where the at least one matching stored context information item includes the received user context information and the link to the storage location of the item of content; and return the matched user context information and the link to the storage location of the item of content in response to the search request. In certain implementations, the storage location of the item of content includes a storage location associated with a second computing device. In certain implementations, the first computing device operates as a context gathering proxy device for the context-sharing server. In certain implementations, the first computing device includes a social networking server.

While certain embodiments herein were described in conjunction with specific circuitry that carries out the functions described, other embodiments are contemplated in which the circuit functions are carried out using equivalent elements executed on one or more programmed processors. General purpose computers, microprocessor based computers, micro-controllers, optical computers, analog computers, dedicated processors, application specific circuits and/or dedicated hard wired logic and analog circuitry may be used to construct alternative equivalent embodiments. Other embodiments could be implemented using hardware component equivalents such as special purpose hardware, dedicated processors or combinations thereof.

Certain embodiments may be implemented using one or more programmed processors executing programming instructions that in certain instances are broadly described above in flow chart form that can be stored on any suitable electronic or computer readable storage medium (such as, for example, disc storage, Read Only Memory (ROM) devices, Random Access Memory (RAM) devices, network memory devices, optical storage elements, magnetic storage elements, magneto-optical storage elements, flash memory, core memory and/or other equivalent volatile and non-volatile storage technologies). However, those skilled in the art will appreciate, upon consideration of the present teaching, that the processes described above can be implemented in any number of variations and in many suitable programming languages without departing from embodiments of the present invention. For example, the order of certain operations carried out can often be varied, additional operations can be added or operations can be deleted without departing from certain embodiments of the invention. Error trapping can be added and/or enhanced and variations can be made in user interface and information presentation without departing from certain embodiments of the present invention. Such variations are contemplated and considered equivalent.

While certain illustrative embodiments have been described, it is evident that many alternatives, modifications, permutations and variations will become apparent to those skilled in the art in light of the foregoing description.

What is claimed is:

1. A method of context-based content sharing at a computing device, comprising:
detecting, at the computing device that comprises a television receiver device with an Internet video link (IVL) that operates as a context gathering proxy device for a context-sharing server, a drag and drop user interface operation of an image icon representing an item of content onto a context sticker rendered via a display of the computing device as part of rendering a social networking website, where the drag and drop user interface operation of the image icon representing the item of content onto the context sticker comprises a request to share the item of content;
prompting, via a user interface dialog box in response to detecting the drag and drop user interface operation of the image icon representing the item of content onto the context sticker, a user to enter user context information for the item of content;
receiving the user context information for the item of content in response to the user entry of the user context information within the user interface dialog box;
determining that a storage location of the item of content comprises a social networking website storage location;
forming a link to the social networking website storage location of the item of content;
determining a geo-location and a time of entry of the user context information; and
sending the user context information, the link to the storage location of the item of content, a context sticker identifier (ID) of the context sticker, the geo-location, and the time of entry of the user context information to the context-sharing server via the IVL, where the context-sharing server publishes the item of content using the user context information.

2. A method of context-based content sharing at a computing device, comprising:
detecting, at the computing device, a request to share an item of content;
receiving user context information for the item of content;
forming a link to a storage location of the item of content; and
sending the user context information and the link to the storage location of the item of content to a context-sharing server, where the context-sharing server publishes the item of content using the user context information.

3. The method according to claim 2, where detecting, at the computing device, the request to share the item of content comprises:
detecting a menu selection to create a context sticker for the item of content;
creating the context sticker comprising the user context information and the link to the storage location of the item of content, where the context sticker comprises a context sticker icon; and
where sending the user context information and the link to the storage location of the item of content to a context-sharing server comprises sending the context sticker to the context-sharing server.

4. The method according to claim 2, where detecting, at the computing device, the request to share the item of content comprises detecting a selection of a context sticker rendered via a display of the computing device.

5. The method according to claim 4, where the context sticker is rendered via the display of the computing device in association with rendering a social networking website on the display of the computing device.

6. The method according to claim 2, where detecting, at the computing device, the request to share the item of content comprises detecting a drag and drop user interface operation of an image icon representing the item of content onto a context sticker.

7. The method according to claim 6, further comprising sending the context sticker to the context-sharing server.

8. The method according to claim 6, further comprising sending a context sticker identifier (ID) of the context sticker to the context-sharing server.

9. The method according to claim 2, further comprising:
prompting, via a user interface dialog box in response to detecting the request to share the item of content, a user to enter the user context information; and
where receiving the user context information for the item of content comprises receiving the user context information in response to user entry of the user context information within the user interface dialog box.

10. The method according to claim 2, further comprising:
determining that the storage location of the item of content comprises a social networking website storage location; and
where forming the link to the storage location of the item of content comprises forming the link to the social networking website storage location.

11. The method according to claim 2, where the computing device comprises a television receiver device with an Internet video link (IVL), and where sending the user context information and the link to the storage location of the item of content to the context-sharing server comprises sending the user context information and the link to the storage location of the item of content to the context-sharing server via the IVL.

12. The method according to claim 2, where the user context information comprises at least one of a user comment, a user rating, a user assigned context category, and a user assigned context keyword.

13. The method according to claim 2, further comprising:
determining a geo-location and a time of entry of the user context information; and
where sending the user context information and the link to the storage location of the item of content to the context-sharing server comprises sending the geo-location and the time of entry of the user context information to the context-sharing server.

14. The method according to claim 2, where the user context information further comprises a social networking account identifier of a user that originated the detected request to share the item of content.

15. The method according to claim 2, where the computing device operates as a context gathering proxy device for the context-sharing server.

16. A computer readable storage medium storing instructions which, when executed on one or more programmed processors, carry out a method according to claim 2.

17. A method of context-based content sharing at a context-sharing server, comprising:
receiving, from a first computing device at the context-sharing server, a request to share an item of content, where the request comprises user context information and a link to a storage location of the item of content;
storing the received user context information and the link to the storage location of the item of content; and
publishing, via the Internet, the user context information and the link to the storage location of the item of content as shared content context information.

18. The method according to claim 17, where:
receiving the request to share the item of content comprises receiving a context sticker identifier (ID) of a context sticker previously published by the context-sharing server at a social networking server accessed by the first computing device; and
publishing, via the Internet, the user context information and the link to the storage location of the item of content as shared content context information comprises updating published context information associated with the context sticker.

19. The method according to claim 17, where receiving the request to share the item of content comprises receiving a context sticker and storing the context sticker with the user context information and the link to the storage location of the item of content.

20. The method according to claim 17, further comprising:
determining whether any subscribed user accounts match the user context information;
determining, in response to determining that at least one subscribed user account matches the user context information, whether at least one server device hosts the matching at least one subscribed user account that matches the user context information; and
where publishing the user context information and the link to the storage location of the item of content as the shared content context information comprises sending the context sticker with the user context information and the link to the storage location of the item of content to the at least one server device that hosts the subscribed user accounts that match the user context information.

21. The method according to claim 17, further comprising:
determining whether any subscribed user accounts match the user context information; and
where publishing the user context information and the link to the storage location of the item of content as the shared content context information comprises sending a notification comprising the user context information and the link to the storage location of the item of content to each subscribed user account determined to match the user context information.

22. The method according to claim 17, further comprising:
receiving a search request comprising context identifying text;
performing a context search of stored context information for context matches;
identifying at least one matching stored context information item, where the at least one matching stored context information item comprises the received user context information and the link to the storage location of the item of content; and
returning the matched user context information and the link to the storage location of the item of content in response to the search request.

23. The method according to claim 17, where the storage location of the item of content comprises a storage location associated with a second computing device.

24. The method according to claim 17, where the first computing device operates as a context gathering proxy device for the context-sharing server.

25. The method according to claim 17, where the first computing device comprises a social networking server.

26. A computer readable storage medium storing instructions which, when executed on one or more programmed processors, carry out a method according to claim 17.

27. An apparatus for context-based content sharing, comprising:
a communication interface; and
a processor programmed to:
detect a request to share an item of content;
receive user context information for the item of content;
form a link to the storage location of the item of content; and
send, via the communication interface, the user context information and the link to the storage location of the item of content to a context-sharing server, where the context-sharing server publishes the item of content using the user context information.

28. The apparatus according to claim 27, where, in being programmed to detect the request to share the item of content, the processor is programmed to:
detect a menu selection to create a context sticker for the item of content;
create the context sticker comprising the user context information and the link to the storage location of the item of content, where the context sticker comprises a context sticker icon; and
where, in being programmed to send the user context information and the link to the storage location of the item of content to a context-sharing server, the processor is programmed to send the context sticker to the context-sharing server.

29. The apparatus according to claim 27, further comprising:
a display; and
where, in being programmed to detect the request to share the item of content, the processor is programmed to detect a selection of a context sticker rendered via the display.

30. The apparatus according to claim 29, where the processor is programmed to render the context sticker via the display in association with rendering a social networking website on the display.

31. The apparatus according to claim 27, where, in being programmed to detect the request to share the item of content, the processor is programmed to detect a drag and drop user interface operation of an image icon representing the item of content onto a context sticker.

32. The apparatus according to claim 31, where the processor is further programmed to send the context sticker to the context-sharing server.

33. The apparatus according to claim 31, where the processor is further programmed to send a context sticker identifier (ID) of the context sticker to the context-sharing server.

34. The apparatus according to claim 27, where the processor is further programmed to:
prompt, via a user interface dialog box in response to detecting the request to share the item of content, a user to enter the user context information; and
where, in being programmed to receive the user context information for the item of content, the processor is programmed to receive the user context information in response to user entry of the user context information within the user interface dialog box.

35. The apparatus according to claim 27, where the processor is further programmed to:
determine that the storage location of the item of content comprises a social networking website storage location; and
where, in being programmed to form the link to the storage location of the item of content, the processor is programmed to form the link to the social networking website storage location.

36. The apparatus according to claim 27, where the apparatus comprises a television receiver device with an Internet video link (IVL), and where, in being programmed to send the user context information and the link to the storage location of the item of content to the context-sharing server, the processor is programmed to send the user context information and the link to the storage location of the item of content to the context-sharing server via the IVL.

37. The apparatus according to claim 27, where the user context information comprises at least one of a user comment, a user rating, a user assigned context category, and a user assigned context keyword.

38. The apparatus according to claim 27, further comprising:
a global positioning system (GPS) module;
a clock module; and
where the processor is further programmed to:
determine a geo-location via the GPS module, and a time of entry of the user context information via the clock module; and
where, in being programmed to send the user context information and the link to the storage location of the item of content to the context-sharing server, the processor is programmed to send the geo-location and the time of entry of the user context information to the context-sharing server.

39. The apparatus according to claim 27, where the user context information further comprises a social networking account identifier of a user that originated the detected request to share the item of content.

40. The apparatus according to claim 27, where the apparatus operates as a context gathering proxy device for the context-sharing server.

41. An apparatus for of context-based content sharing, comprising:
a memory; and
a processor programmed to:
receive, from a first computing device, a request to share an item of content, where the request comprises user context information and a link to a storage location of the item of content;
store the received user context information and the link to the storage location of the item of content within the memory; and
publish, via the Internet, the user context information and the link to the storage location of the item of content as shared content context information.

42. The apparatus according to claim 41, where, in being programmed to:
receive the request to share the item of content, the processor is programmed to receive a context sticker identifier (ID) of a context sticker previously published by the context-sharing server at a social networking server accessed by the first computing device; and
publish, via the Internet, the user context information and the link to the storage location of the item of content as shared content context information, the processor is programmed to update published context information associated with the context sticker.

43. The apparatus according to claim 41, where, in being programmed to receive the request to share the item of content, the processor is programmed to receive a context sticker and store the context sticker with the user context information and the link to the storage location of the item of content within the memory.

44. The apparatus according to claim 41, where the processor is further programmed to:
determine whether any subscribed user accounts match the user context information;
determine, in response to determining that at least one subscribed user account matches the user context information, whether at least one server device hosts the matching at least one subscribed user account that matches the user context information; and
where, in being programmed to publish the user context information and the link to the storage location of the item of content as the shared content context information, the processor is programmed to send the context sticker with the user context information and the link to the storage location of the item of content to the at least one server device that hosts the subscribed user accounts that match the user context information.

45. The apparatus according to claim 41, where the processor is further programmed to:
determine whether any subscribed user accounts match the user context information; and
where, in being programmed to publish the user context information and the link to the storage location of the item of content as the shared content context information, the processor is programmed to send a notification comprising the user context information and the link to the storage location of the item of content to each subscribed user account determined to match the user context information.

46. The apparatus according to claim 41, where the processor is further programmed to:
receive a search request comprising context identifying text;
perform a context search of stored context information for context matches;
identify at least one matching stored context information item, where the at least one matching stored context information item comprises the received user context information and the link to the storage location of the item of content; and
return the matched user context information and the link to the storage location of the item of content in response to the search request.

47. The apparatus according to claim 41, where the storage location of the item of content comprises a storage location associated with a second computing device.

48. The apparatus according to claim 41, where the first computing device operates as a context gathering proxy device for the context-sharing server.

49. The apparatus according to claim 41, where the first computing device comprises a social networking server.
